(19) United States
(12) Patent Application Publication
(10) Pub. No.: US 2010/0014461 A1
(43) Pub. Date: Jan. 21, 2010

(54) System and Method for Creating Multiple Mobility Profiles per Subscriber in Wireless Communications Systems

(75) Inventor: Alaa-addin Moussa, Oceanside, CA (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/502,002

(22) Filed: Jul. 13, 2009

Related U.S. Application Data
(60) Provisional application No. 61/081,616, filed on Jul. 17, 2008.

(51) Int. Cl. H04W 4/00

(52) U.S. Cl. 370/328

(57) ABSTRACT

A system and method for creating multiple mobility profiles per subscriber in wireless communications systems is provided. A method includes receiving a request for service from a terminal, sending a request for authorization of the terminal to a server, receiving, in response to the request for authorization, an indication that the terminal is authorized, and granting access to the terminal. The indication includes a mobility classification associated with the terminal. The mobility classification is based on the terminal's operating conditions.

This application claims the benefit of U.S. Provisional Application No. 61/081,616, filed on Jul. 17, 2008, entitled “System and Method for Creating Multiple Mobility Profiles Per Subscriber in Wireless Networks,” which application is hereby incorporated herein by reference.

### TECHNICAL FIELD

The present invention relates generally to wireless communications, and more particularly to a system and method for creating multiple mobility profiles per subscriber in wireless communications systems.

### BACKGROUND

In a deployment of a wireless communications system, an operator (or service provider) may need (or wish) to control the mobility of terminals (also sometimes referred to as subscriber terminals, subscribers, subscriber units, mobile stations, User Equipment, and the like) that access the communications system to receive services subscribed thereto. The need to control the mobility of terminals may arise due to regulatory restrictions associated with a spectrum license granted to the operator (Fixed Service only). For example, in a given locality the operator may only have a Fixed Service only license that may prohibit it from providing mobility service (Mobility Service only) to all terminals (even those that are capable of mobility and are paying for Mobility Service). Therefore, terminals operating in the operator's communications system may have their mobility restricted by law.

Additionally, the need to control the mobility of terminals may also be due to a commercial need to provide tiered services, e.g., wherein the operator charges different rates based on a terminal's mobility or lack thereof. For instance, a terminal of a subscriber who pays for Fixed Service may have its mobility restricted, while a terminal of a subscriber who pays for Mobility Service (typically at higher cost) may not have mobility restrictions if there are no regulatory restrictions.

A geographical area where the terminal or subscriber may receive service may normally be setup in the terminal's (or subscriber's) profile in a core system database. For Fixed Service, a terminal may be allowed to access the communications system from a single geographical area, typically through a single access point (AP) (also sometimes referred to as a base station (BS), base transceiver station (BTS), and so forth), while for Nomadic Service, a terminal may be allowed to access the communications system from different geographical areas (APs), but the service and the session may only be maintained as long as the terminal/subscriber is connected to an initial point of access (the AP through which it initially connects to the communications system).

However, the service that the terminal or subscriber may receive may also be dependent on a location of the terminal's initial point of access (also commonly referred to as initial point of entry). For example, at a first initial point of access, the terminal's service provider may have a spectrum license that allows the service provider to provide only Fixed Service (independent of the terminal's actual service level), while at a second initial point of entry (typically at a different locality), the terminal's service provider may have a spectrum license that allows the service provider to provide Fixed Service, Nomadic Service, and Mobility Service to its terminals, dependent on the terminal's actual service level.

Therefore, there is a need to provide multiple terminal profiles for a single terminal, wherein an actual terminal profile provided to a terminal may be based on factors that might be encountered in a wireless communications system, including the terminal's initial point of access, whether the terminal is at a home communications system or a visiting communications system, and so forth.

### SUMMARY OF THE INVENTION

These and other problems are generally solved or circumvented, and technical advantages are generally achieved, by embodiments of a system and method for creating multiple mobility profiles per subscriber in wireless communications systems.

In accordance with an embodiment, a method of operating in a wireless communication system is provided. The method includes receiving a request for service from a terminal, sending a request for authorization of the terminal to a server, receiving, in response to the request for authorization, an indication that the terminal is authorized, and granting access to the terminal. The indication includes a mobility classification associated with the terminal, and the mobility classification is based on the terminal's operating conditions.

In accordance with another embodiment, a method of operating in a wireless communication system is provided. The method includes receiving a request for authorization of a terminal from an access server, and determining if the terminal is authorized to operate in the wireless communications system. The method also includes in response to determining that the terminal is authorized to operate in the wireless communications system, selecting a mobility classification for the terminal based on the terminal's operating conditions, and sending a first indication to the access server. The method further includes sending a second indication to the access server in response to determining that the terminal is not authorized to operate in the wireless communications system. The first indication includes indications indicating that the terminal is authorized to operate in the wireless communications system and the terminal's mobility classification, and the second indication indicates that the terminal is not authorized to operate in the wireless communications system.

In accordance with another embodiment, a method of operating in a wireless communication system is provided. The method includes receiving a request for authorization of a terminal from a base station, querying an authentication and authorization device regarding the terminal, receiving, in response to the query, a first indication that the terminal is authorized, and sending a terminal authorized message to the base station. The first indication includes a mobility classification associated with the terminal, and the mobility classification is based on the terminal's identity and operating conditions.

An advantage of an embodiment is that multiple terminal profiles for a single terminal may be available for selection based on factors that the terminal may encounter in a wireless communications system. This allows for additional flexibility in the services that can be provided to the terminal.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a wireless communications system;

FIG. 1b is a diagram of a portion of a communications system;

FIG. 2 is a diagram of a message exchange of operations for providing a terminal profile for a terminal for use in implementing mobility restrictions in a wireless communications system;

FIG. 3 is a flow diagram of BS operations in implementing mobility restrictions;

FIG. 4 is a flow diagram of NAS operations in implementing mobility restrictions; and

FIG. 5 is a flow diagram of AAA server operations in implementing mobility restrictions.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a WiMAX wireless communications system. The invention may also be applied, however, to other wireless communications systems adherent to other communications standards, such as IEEE 802.16, Long Term Evolution, and so forth.

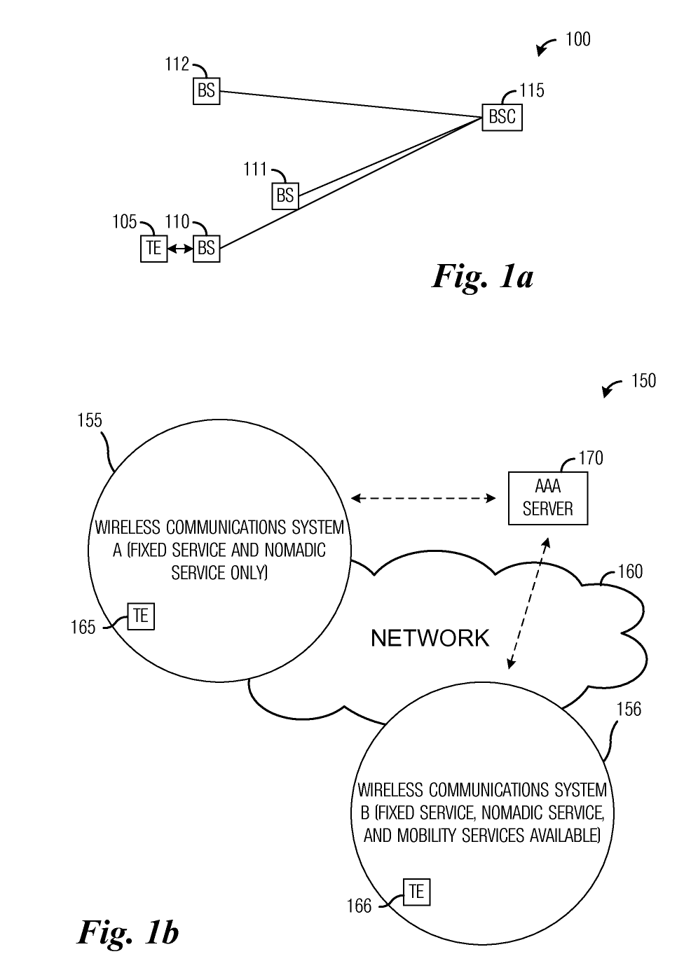

FIG. 1a illustrates a wireless communications system 100. Wireless communications system 100 includes a terminal (TE), such as TE 105, a number of base stations (BS), such as BS 110, BS 111, and BS 112, and a base station controller (BSC) 115. TE 105 may be served wirelessly by BS 110, which may transmit to TE 105 as well as grant transmission opportunities to TE 105, which may be used by TE 105 to transmit to BS 110. Communications to and from TE 105 flow through BS 110. If TE 105 initiated service in wireless communications system 100 with BS 110, then BS 110 may be referred to as an initial point of access for TE 105.

BSC 115 may be connected to the BSs and may be responsible for operations such as allocation of channels, controls handoffs, and so forth. Additionally, BSC may also serve as intermediary between the TEs and the BSs in wireless communications system 100 and other services and devices not in wireless communications system 100, such as authorization, authentication, and accounting (AAA) servers, information and data servers, multimedia servers, other wired and wireless communications systems, and so forth.

If TE 105 has Mobility Service, then as TE 105 moves around, it may move out of a service area of BS 110 and enter a service area of another BS, such as BS 112. When this occurs, a handoff may be performed and TE 105 may switch to being served by BS 112 instead of BS 110. Typically, the handoff may be initiated by BS 110, although in some wireless communications systems, TE 105 may be able to indicate that it wishes to participate in a handoff.

The ability of TE 105 to participate in a handoff may be dependent upon a terminal profile of TE 105. The terminal profile of TE 105 may include a mobility classification of TE 105, which may be used to indicate if mobility restrictions are to be implemented and a local redirection zone (if any) is to be in effect. The mobility classification of TE 105 may also be used to indicate if session continuity is enabled or disabled for TE 105.

Typically, a terminal may have a single terminal profile that may be used to provide services to the terminal within a wireless communications system. However, if the terminal is allowed to roam and connect to more than one wireless communications system, then there may be a need for multiple terminal profiles. When the terminal has multiple terminal profiles, factors that the terminal may encounter in a wireless communications system may be used to select a terminal profile for the terminal.

FIG. 1b illustrates a portion of a communications system 150. Communications system 150 includes a first wireless communications system (“wireless communications system A”) 155 and a second wireless communications system (“wireless communications system B”) 156. First wireless communications system 155 and second wireless communications 156 may be disjoint and may be physically separated by large distances. For example, first wireless communications system 155 may be implemented in a first city and second wireless communications system 156 may be implemented in a second city.

First wireless communications system 155 and second wireless communications system 156 may be coupled to a network, such as the Internet, 160. Through network 160, terminals in first communications system 155 (for example, TE 165) and/or second communications system 156 (for example, TE 166) may communicate with one another or with other resources that are part of or attached to network 160.

First wireless communications system 155 and second wireless communications system 156 may also be connected to an authorization, authentication, and accounting (AAA) server 170. The connection to AAA server 170 may be a direct connection or through network 160. There may be multiple AAA servers. For example, there may be a home AAA server that is the AAA server used to authorize/authenticate a terminal in its home communications system, and there may be a visiting AAA server that is the AAA server used to authorize/authenticate a terminal when it is joining a visiting communications system.

Since first wireless communications system 155 and second wireless communications system 156 may be located at in different geographical areas, available mobility services may differ even if a single service provider is operating both wireless communications systems. For example, in the first city, the service provider may only have a spectrum license that allows only Fixed Service, while in the second city, the service provider may have a spectrum license that allows all forms of service (Fixed Service, Nomadic Service, Mobility Service, and so on). Furthermore, if the wireless communications systems are operated by different service providers, the types of service available to a terminal may also be dependent on a service agreement between the various service providers in addition to any regulatory restrictions.

Since the services available to a terminal may differ based on factors such as the terminal's initial point of access, whether the terminal is at a home communications system or a visiting communications system, wireless communications system service provider, and so forth, there is a need to provide different terminal profiles to the terminal based on these factors.

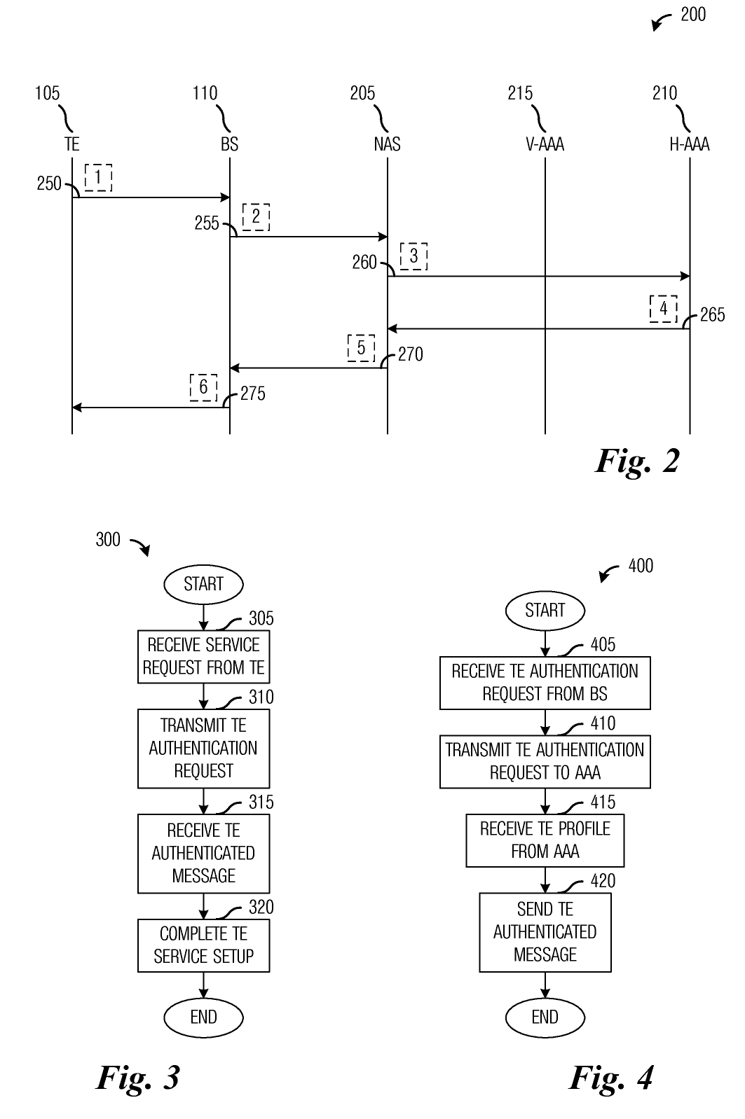

FIG. 2 illustrates a message exchange of operations 200 for providing a terminal profile for a terminal for use in implementing mobility restrictions in a wireless communications system. Operations 200 may be indicative of operations taking place in a wireless communications system, such as a WiMAX compliant wireless communications system, implementing mobility restrictions on TEs operating in the wireless communications system. Operations 200 may occur each time a TE, such as TE 105, initially enters the wireless communications system.

Operations 200 may begin when the TE initially enters the wireless communications system. When the TE initially enters the wireless communications system, it may request service from a BS, such as BS 110, in the wireless communications system (shown as event #1 250). The TE may initially enter the wireless communications system when it is initially powered on within a coverage area of the wireless communications system, it is attempting to reestablish previously established service with the wireless communications system that has expired or otherwise terminated, it has roamed into the coverage area of the wireless communications system, and so forth.

As the BS receives the request for service from the TE, the BS may send an authorization/authentication request for the TE to a network access server (NAS), such as NAS 205 (shown as event #2 255). The authorization/authentication request sent to the NAS may include information such as the TE's identifier, the BS's identifier, and the BS's local redirection zone (if the BS has one).

The NAS may query a home AAA (H-AAA) server (or some other authorization/authentication server), such as H-AAA 210, regarding the TE. If the TE is operating outside of its home communications system, i.e., roaming, the NAS query may be sent to a visiting AAA (V-AAA) server, such as V-AAA 215 (shown as event #3 260). The query may include information such as the TE's identifier, and so forth.

The H-AAA server (or the V-AAA server) may search configured information in its subscriber database to determine and select a mobility classification for the TE based on the TE's operating conditions. An example of the TE's operating conditions may be its current communications system's capabilities (either the TE's current home communications system or its current visiting communications system). For example, if the TE has Mobility Service but the TE's current communications system supports only Fixed Service or Nomadic Service, the H-AAA server may select a mobility classification for the TE that reflects only Fixed Service and/or Nomadic Service. However, if the TE has Fixed Service but the TE's current communications system supports Fixed Service, Nomadic Service, Mobility Service, and so forth, the H-AAA server may select a mobility classification for the TE that reflects only Fixed Service.

Other operating conditions may be communications system load, number of other TEs in the communications system, and so forth. Additionally, operating conditions may include a spectrum license that the service provider of the communications system has licensed from regulators, an agreement between the service provider of the TE's home communications system and the service provider of the TE's visiting communications system if the TE is visiting the communications system. A further example of operating conditions may include the TE's service subscription, i.e., the service level paid for by the TE's owner or user.

The selection of the mobility classification may be made based on a highest common service level of a combination of the operating conditions. For example, if the communications system supports Fixed, Nomadic, and Mobility, but the TE's service is only Fixed Service, then the mobility classification of the TE may be limited to Fixed Service, which is the highest common service level. Similarly, if the TE's service includes Fixed, Nomadic, and Mobility Services, but the communications system supports Fixed Service and Nomadic Service (perhaps due to regulatory restrictions), then the mobility classification of the TE may be limited to Fixed Service and Nomadic Service.

The mobility classification may then be passed back to the NAS so that the mobility management rules may be applied accordingly (shown as event #4 265). In addition to the mobility classification, other information may be provided by the H-AAA to the NAS, such as accounting/billing information, and so on.

The NAS may then indicate to the BS that the authorization/authentication of the TE was successful, i.e., the identity of the TE has been authenticated and the TE is authorized to receive service, and service setup for the TE may be completed (shown as event #5 270). In addition to indicating to the BS that the authorization/authentication of the TE was successful, the NAS may also send the mobility classification to the BS (or a base station controller (BSC) depending on implementation), where mobility restrictions are implemented. For example, if mobility restrictions are implemented in the BS, then the NAS may send the mobility classification to the BS. Similarly, if the mobility restrictions are implemented in the BSC, then the NAS may send the mobility classification to the BSC. For a detailed discussion of the implementation of mobility restrictions, please refer to co-assigned patent application U.S. patent application Ser. No. 12/495,878, entitled “System and Method for Mobility Restriction in Wireless Communications Systems,” filed Jul. 1, 2009, which is incorporated herein by reference. The BS may then complete the service setup for the TE (shown as event #6 275).

FIG. 3 illustrates a flow diagram of BS operations 300 in implementing mobility restrictions. BS operations 300 may be indicative of operations occurring in a BS, such as BS 110, of a wireless communications system, such as wireless communications system 100. BS operations 300 may occur during normal operations of the wireless communications system as TEs, such as TE 105, initially enters the wireless communications system.

BS operations 300 may begin with the BS receiving a service request from the TE (block 305). The service request from the TE may include an identifier for the TE, which may be used to identify and authenticate/authorize the TE. The BS may send to a NAS, such as NAS 205, a request to authenticate/authorize the TE, such as a TE authentication/authorization request (block 310).

The BS may then receive a message from the BSC, such as a TE authenticated message, indicating that the TE has been authenticated/authorized (block 315). The TE authenticated message may include information such as the TE's priority, service data rate, and so forth. In an alternative embodiment where the BS performs redirection, the TE authenticated message may also include a mobility classification of the TE (Fixed/Nomadic Service, Mobility Service, Mobility Service level, and so on), which the BS may use in limiting the TE's mobility if needed. The BS may then complete the TE service request (block 320). Once the BS completes the TE service request, the BS becomes the TE's initial point of access and BS operations 300 may terminate.

FIG. 4 illustrates a flow diagram of NAS operations 400 in implementing mobility restrictions. NAS operations 400 may be indicative of operations occurring in a NAS, such as NAS 205, of a wireless communications system, such as wireless communications system 100. NAS operations 400 may occur during normal operations of the wireless communications system as a TE, such as TE 105, initially enters the wireless communications system.

NAS operations 400 may begin with the NAS receiving a message, such as a TE authentication/authorization request, from a BS, such as BS 110 (block 405). The message may request that the TE be authenticated/authorized. The TE authentication/authorization request may be a result of a service request from the TE as it initially enters the wireless communications system. The TE authentication/authorization request includes the TE's identifying information, such as an identifier.

The NAS sends the message (TE authentication/authorization request) to an AAA (or some other authentication/authorization) server, such as a H-AAA 210 if the TE is attempting to join its home communications system or a V-AAA 215 if the TE is attempting to join a visiting communications system (block 410). The TE authentication/authorization request includes the TE's identifying information. The NAS may then receive a message, such as a TE authentication/authorization request granted message, from the AAA server, wherein the TE authentication/authorization request may include a profile for the TE (block 415). The message may indicate that the TE was successfully authenticated/authorized. The profile for the TE may include a mobility classification for the TE, which may specify the mobility service, Fixed Service, Nomadic Service, or Mobility Service, for example, of the TE.

The selection of the mobility classification by the AAA server may be based on factors that the TE may encounter in the wireless communications system, such as the TE's initial point of access, whether the TE is at a home communications system or a visiting communications system, and so forth. In an alternative embodiment, the profile for the TE may also include a Mobility Service level if the mobility service of the TE is Mobility Service. The NAS may then send a TE authenticated message to the BS (block 420) and NAS operations 400 may then terminate.

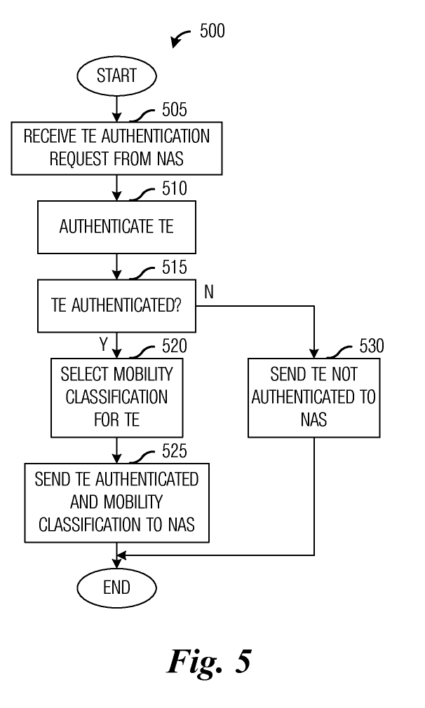

FIG. 5 illustrates a flow diagram of AAA server operations 500 in implementing mobility restrictions. AAA server operations 500 may be indicative of operations occurring in an AAA server, such as H-AAA server 210 or V-AAA server 215, of a wireless communications system, such as wireless communications system 100. AAA server operations 500 may occur during normal operations of the wireless communications system as a TE, such as TE 105, initially enters the wireless communications system. If the TE is entering its home wireless communications system, then the AAA server may be H-AAA server 210, while if the TE is entering a visiting wireless communications system, then the AAA server may be a V-AAA server 215.

AAA server operations 500 may begin with the AAA server receiving a message, such as a TE authentication/authorization request, from a NAS, such as NAS 205 (block 505). The message may be used to request the AAA server authenticate/authorize the TE. The TE authentication/authorization request may be a result of a service request from the TE as it initially enters the wireless communications system. The TE authentication/authorization request includes the TE's identifying information, such as identifier.

The AAA server may then authenticate the TE (block 510). The authentication of the TE may involve the exchange of authentication protocol messages, such as those of Radius and/or Diameter authentication protocols. The authentication of the TE may make use of the TE's identifying information as well as passwords, and so forth.

If the TE is authentic and is authorized to operate in the wireless communications system (block 515), then the AAA server may select a mobility classification for the TE (block 520). The selection of the mobility classification for the TE may be based on the TE's identity as well as operating conditions of the TE. Operating conditions of the TE may include the wireless communications system's capabilities, a spectrum license that the service provider of the communications system has licensed from regulators, an agreement between the service provider of the TE's home communications system and the service provider of the TE's visiting communications system if the TE is visiting the communications system, the TE's service subscription, communications system load, number of other TEs in the communications system, and so forth.

The AAA server may select the mobility classification based on a highest common service level of a combination of the operating conditions. For example, if the communications system supports Fixed, Nomadic, and Mobility, but the TE's service is only Fixed Service, then the mobility classification of the TE may be limited to Fixed Service, which is the highest common service level.

The AAA server may then send a reply to the TE authentication/authorization request (block 525). The reply may include indications indicating that the TE has been authenticated and is authorized to operate in the wireless communications system and the mobility classification of the TE. AAA server operations 500 may then terminate.

If the TE is not authorized to operate in the wireless communications system (block 515), then the AAA server may send a reply to the TE authentication/authorization request (block 530). The reply may include indications that the TE has not been authenticated or some how is not authorized to operate in the wireless communications system and AAA server operations 500 may then terminate.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of operating in a wireless communication system, the method comprising:
receiving a request for service from a terminal;
sending a request for authorization of the terminal to a server;
receiving, in response to the request for authorization, an indication that the terminal is authorized, the indication comprises a mobility classification associated with the terminal, wherein the mobility classification is based on the terminal's operating conditions; and
granting access to the terminal.

2. The method of claim 1, wherein the mobility classification is further based on the terminal's identity.

3. The method of claim 1, wherein the terminal's operating conditions comprises the capabilities of the wireless communications system, the wireless communications system's service provider's spectrum license, or the terminal's service.

4. The method of claim 1, wherein the request for authorization comprises an identity of the terminal.

5. The method of claim 1, wherein the wireless communications system compliant with IEEE 802.16 protocols.

6. The method of claim 5, wherein the wireless communications system is compliant with WiMAX protocols.

7. The method of claim 1, wherein the server comprises a network access server.

8. A method of operating in a wireless communication system, the method comprising:
receiving a request for authorization of a terminal from an access server;
determining if the terminal is authorized to operate in the wireless communications system;
in response to determining that the terminal is authorized to operate in the wireless communications system,
selecting a mobility classification for the terminal based on the terminal's operating conditions, and
sending a first indication to the access server, wherein the first indication comprises indications indicating that the terminal is authorized to operate in the wireless communications system and the terminal's mobility classification; and
in response to determining that the terminal is not authorized to operate in the wireless communications system, sending a second indication to the access server, wherein the second indication indicates that the terminal is not authorized to operate in the wireless communications system.

9. The method of claim 8, wherein determining if the terminal is authorized further comprises authenticating the terminal.

10. The method of claim 8, wherein the terminal's operating conditions comprises the capabilities of the wireless communications system, the wireless communications system's service provider's spectrum license, or the terminal's service level.

11. The method of claim 8, wherein the capabilities of the wireless communications system comprises Fixed Service, Nomadic Service, or Mobility Service.

12. The method of claim 10, wherein the service provider's spectrum license comprises Fixed Service or Mobility Service.

13. The method of claim 10, wherein the terminal's service level comprises Fixed Service, Nomadic Service, or Mobility Service.

14. The method of claim 10, wherein the mobility classification is selected as a highest service level common to a combination of the terminal's operating conditions.

15. The method of claim 10, wherein the mobility classification is further selected based on the terminal's identity.

16. A method of operating in a wireless communication system, the method comprising:
receiving a request for authorization of a terminal from a base station;
querying an authentication and authorization device regarding the terminal;
receiving, in response to the query, a first indication that the terminal is authorized, the first indication comprises a mobility classification associated with the terminal, wherein the mobility classification is based on the terminal's identity and operating conditions; and
sending a terminal authorized message to the base station.

17. The method of claim 16, wherein the authentication and authorization device comprises an authorization, authentication, and accounting (AAA) server.

18. The method of claim 17, wherein the wireless communication system is the terminal's home communications system, and wherein the authentication and authorization device comprises a home AAA server.

19. The method of claim 17, wherein the wireless communication system is not the terminal's home communications system, and wherein the authentication and authorization device comprises a visiting AAA server.

20. The method of claim 16, further comprising, receiving in response to the query, a second indication that the terminal is not authorized.
